(19) United States
(12) Patent Application Publication
(10) Pub. No.: US 2010/0220370 A1
(43) Pub. Date: Sep. 2, 2010

(54) IMAGE READING APPARATUS AND IMAGE FORMING APPARATUS

(75) Inventors: Sueo Ueno, Shizuoka (JP); Hiroyuki Shiraishi, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/709,990

(22) Filed: Feb. 22, 2010

Related U.S. Application Data
(60) Provisional application No. 61/156,384, filed on Feb. 27, 2009.

(51) Int. Cl. H04N 1/04

(52) U.S. Cl. 358/475

(57) ABSTRACT

An image reading apparatus includes: an image-signal output unit including plural light-emitting elements provided at equal intervals in a main scanning direction and a lens; and a driving unit configured to control electric currents applied to the light-emitting elements such that amounts of received light in the photoelectric conversion elements at both the ends in the main scanning direction supplement an amount of a light beam that is emitted from a peripheral area on a lens surface of the lens and decreases.

### CROSS-REFERENCE TO RELATED APPLICATION

The present application claims priority under 35 U.S.C. 119 to U.S. Provisional Application Ser. No. 61/156,384, entitled IMAGE FORMING APPARATUS, to Ueno et al., filed on Feb. 27, 2009, the entire disclosure of which is incorporated herein by reference.

### TECHNICAL FIELD

The present invention relates to an image reading apparatus and an image forming apparatus.

### BACKGROUND

In the past, in an optical system of a scanner or an MFP (Multi Function Peripheral), an LED (Light-emitting Diode) array is mainly used as a light source for illuminating an original document.

The use of the LED as the light source leads to advantages such as long life, high current-to-light conversion efficiency, robustness against vibration, and a narrow light-emission wavelength band.

When the optical system is a reduction optical system including a line sensor, the optical system folds reflected light from an original document using plural mirrors and leads the light to a lens. The lens focuses, on one line sensor, color image information on the document surface.

The one line sensor includes linearly-arrayed plural CCDs (Charge Coupled Device). A direction in which the CCDs are arrayed is a main scanning direction. The main scanning direction indicates a depth direction of a housing of the scanner or the MFP.

JP-A-2008-193374 discloses an image reading apparatus in which an LED array is used in a light source.

Japanese Patent 3172206 teaches an image reading apparatus in which plural light-emitting diodes are more densely arranged in the center than at both the ends. Japanese Patent 3172206 discloses that an amount of light in the center in the longitudinal direction of the light-emitting diode array is set larger than an amount of light at both the ends of the array.

However, an amount of focused light is not uniform in the direction in which the CCDs are arrayed on the line sensor. The nonuniformity is caused by a cosine fourth power characteristic of the lens. The cosine fourth power characteristic is described in, for example, JP-A-2006-180297.

The cosine fourth power characteristic indicates a characteristic that an amount of light reaching an image surface in an amount of light passing through a lens having an aspherical lens surface decreases depending on an incident angle θ of the light with respect to an optical axis of the lens. The amount of light passing through the lens decreases in proportion to cos⁴ θ.

An optical path in the CCD located in the center of the line sensor is the shortest. Both optical paths in the CCDs located at both the ends of the line sensor are the longest. An amount of light reaching the CCDs located at both the ends of the line sensor is smaller than an amount of light reaching the CCD located in the center of the line sensor.

For example, when the scanner reads a white image, because of the influence of the cosine fourth power characteristic of the lens, an amount of received light of the CCD located in the center in the main scanning direction on the line sensor is smaller than an amount of received light of the CCD located at one of the ends.

Specifically, when the scanner or the MFP performs reading and exposure of a document image, an amount of light emitted from a circumferential portion on the lens surface away from the optical axis of the lens decreases. The decrease in the amount of light causes luminance unevenness. Therefore, there is concern about deterioration in an S/N (Signal to Noise) ratio of an image signal subjected to shading correction by an image processing unit.

### SUMMARY

It is an object of the present invention to provide an image reading apparatus including a current driving unit configured to control electric currents supplied to light-emitting elements linearly arranged at equal intervals.

In an aspect of the present invention, an image reading apparatus includes: an image-signal output unit including plural light-emitting elements provided at equal intervals in a main scanning direction on a substrate, an optical system configured to condense reflected light from an exposed original document, a lens configured to collect reflected light, plural photoelectric conversion elements configured to photoelectrically convert light from the lens, and a signal processing unit configured to generate line image data in the main scanning direction of the original document using signals photoelectrically converted and output by the photoelectric conversion elements; and a driving unit configured to control electric currents applied to the light-emitting elements such that amounts of received light in the photoelectric conversion elements at both ends in the main scanning direction, which receive a light beam made incident at an incident angle larger than an incident angle of a light beam made incident on the photoelectric conversion element in the center in the main scanning direction from the lens, supplement an amount of a light beam that is emitted from a peripheral area on a lens surface of the lens and decreases.

### DESCRIPTION OF THE DRAWINGS

FIG. 1 is a diagram of an image forming apparatus according to a first embodiment;

FIG. 2A is a perspective view of a light source including plural light-emitting elements;

FIG. 2B is a perspective view of a document surface on which light is irradiated;

FIG. 3 is a diagram of an example of a circuit block of the light source;

FIG. 4A is a plan view of an imaging surface of a photoelectric conversion element;

FIG. 4B is a top view of a lens and the photoelectric conversion element;

FIG. 4C is a diagram of a configuration example of a control system for the image forming apparatus according to the first embodiment;

FIG. 5 is a diagram of a distribution of light of the light source controlled by a current driving unit;

FIG. 6 is a circuit block diagram of a light source used in an image reading apparatus according to a second embodiment;

FIG. 7 is a diagram of a distribution of light of a light source shown in FIG. 6;

FIG. 8 is a circuit block diagram of a light source used in an image reading apparatus according to a third embodiment;

FIG. 9 is a diagram of a distribution of light of the light source shown in FIG. 8;

FIG. 10 is a diagram of a configuration example of a control system for an image forming apparatus according to a fourth embodiment;

FIG. 11 is a circuit block diagram of a first light source used in an image reading apparatus according to the fourth embodiment;

FIG. 12 is a circuit block diagram of a second light source used in the image reading apparatus according to the fourth embodiment; and

FIG. 13 is a circuit block diagram of a third light source used in the image reading apparatus according to the fourth embodiment.

### DETAILED DESCRIPTION

Throughout this description, the embodiments and examples shown should be considered as exemplars, rather than limitations on the apparatus.

Image reading apparatuses and image forming apparatuses according to embodiments are explained in detail below with reference to the accompanying drawings as examples. In the respective figures, the same components are denoted by the same reference numerals and signs and redundant explanation is omitted.

### First Embodiment

An image reading apparatus according to a first embodiment is a scanner configured to read an image from a document surface. An image forming apparatus according to the first embodiment is an MFP configured to print the image read by the scanner or output the image as electronic data.

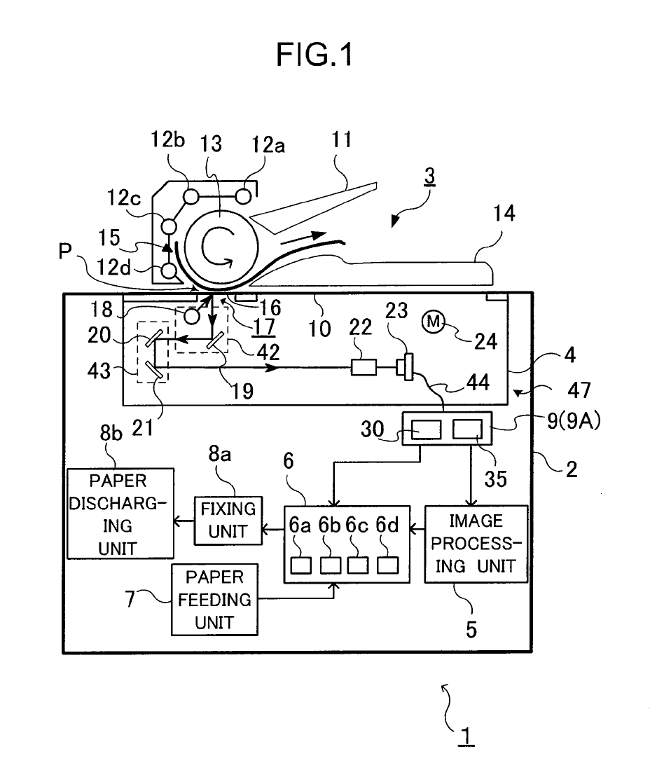

FIG. 1 is a diagram of the MFP. An MEP 1 includes a housing 2, a document conveying unit 3, a scanner 4, an image processing unit 5, a print process unit 6, a paper feeding unit 7, a fixing unit 8a, a paper discharge unit 8b, and a control substrate 9.

The document conveying unit 3 conveys a bundle of original documents to a reading position P one by one and presses the original document on a glass plate (a transparent member) 10 against the surface of the glass plate 10. An ADF (Automatic Document Feeder) is used in the document conveying unit 3.

The document conveying unit 3 includes a document tray 11 in which an original document is set, rollers 12a, 12b, 12c, and 12d having rotating shafts parallel to one another, a drum 13 driven to rotate in an arrow direction, and a table 14 configured to lead the original document to the outside of the document conveying unit 3.

The roller 12a picks up the original document in the document tray 11. The rollers 12b to 12d convey the picked-up original document to the outer circumferential surface of the drum 13. A conveying path 15 is defined by the drum 13 and the rollers 12a to 12d.

A contact glass (a transparent member) 16 is provided below the conveying path 15. A space including a part of the conveying path 15 and the contact glass 16 forms a slit 17. The slit 17 blocks apart of reflected light from the original document.

The scanner 4 reads an image on a document surface. The scanner 4 generates an image signal and outputs the image signal to the image processing unit 5.

As reading and exposure, the scanner 4 exposes the document surface using plural LEDs (light-emitting elements) and, after the exposure, condenses light reflected on the document surface using a reduction optical system. CCDs (photoelectric conversion elements) arrayed in a line shape as an image sensor read the light, whereby the scanner 4 obtains digital image data.

The scanner 4 includes a light source 18, mirrors (reflecting members) 19, 20, and 21, a lens 22, a CCD sensor 23, and a motor 24. The light source 18 is an LED array configured to generate light irradiated on an original document.

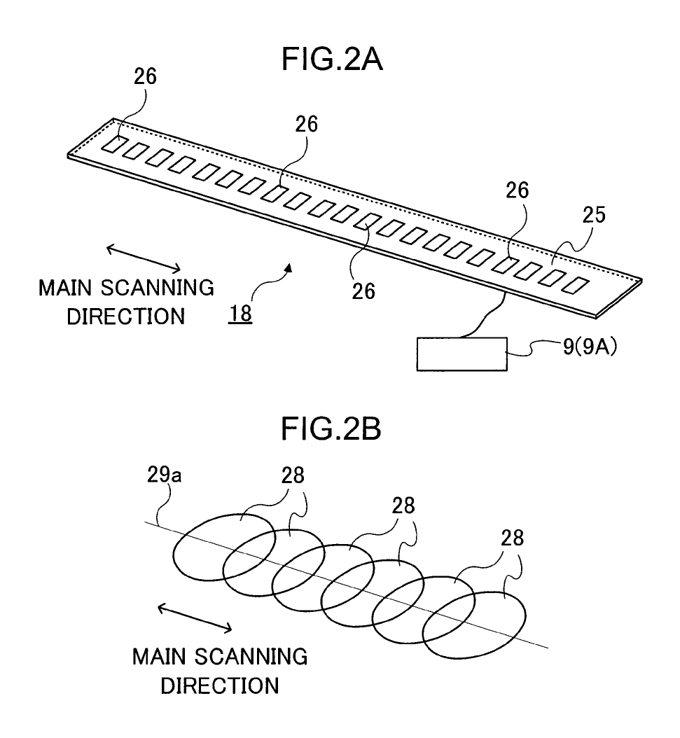

FIG. 2A is a perspective view of the light source 18. The light source 18 includes a substrate 25 having a circuit pattern formed on a surface on one side, plural LED chips (light-emitting elements) 26 provided at equal intervals along the longitudinal direction of the substrate 25, and a not-shown wiring pattern configured to supply electric currents having fixed values different from one another, which are outputted from the control substrate 9, to the LED chips 26.

The LED chips 26 are elements, light emission amounts of which are changed according to a value of an electric current. All the LED chips 26 have substantially the same current-to-light emission amount characteristics. All the LED chips 26 have the same wavelength characteristic during light emission.

The substrate 25 is held horizontally. The substrate 25 is held such that the substrate surface inclines. The LED chips 26 are provided such that an irradiation direction of light from the LED chips 26 is orthogonal to the substrate surface. The light source 18 has a line shape as a whole.

FIG. 2B is a perspective view of a document surface on which light is irradiated. In the figure, end faces of light beams 28 on the document surface viewed from below are shown.

The light beams 28 of the LED chips 26 have directivities. The light beams 28 of the LED chips 26 are superimposed, whereby light is irradiated on a liner area 29a on the document surface in the reading position P. Portions where an amount of light is large and portions where an amount of light is small are formed in the main scanning direction of the linear area 29a by the superimposition of the light beams 28. In this way, a distribution of light is formed.

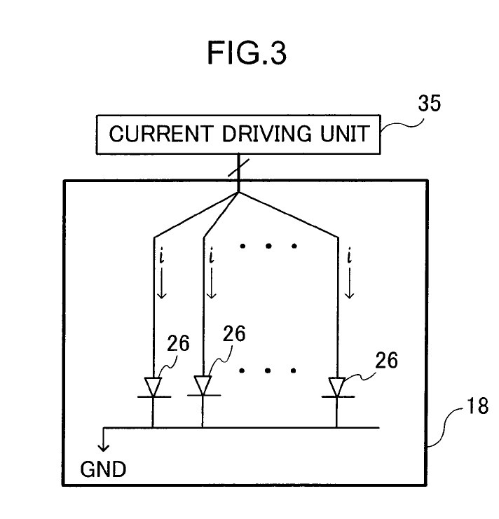

FIG. 3 is a circuit block diagram of the light source 18. In FIG. 3, components same as those shown in the figures referred to above are denoted by the same reference numerals. The plural LED chips 26 are connected in parallel between a driver circuit (a current driving unit 35 explained later) configured to supply an electric current having a desired value and a grounding conductor. Electric currents are respectively supplied to the LED chips 26.

What is important in FIGS. 2A and 2B is that current driving by the control substrate 9 changes the distribution of light in the linear area 29a. The control substrate 9 outputs a control signal to the driver circuit such that electric currents to the LED chips 26 located at both the ends in the longitudinal direction of the substrate 25 are larger than an electric current to one LED chip 26 located in the center in the longitudinal direction.

Referring back to FIG. 1, the mirror 19 leads the reflected light from the original document to the mirror 20. The mirror 20 leads the reflected light from the mirror 19 to the mirror 21. The mirrors 20 and 21 are provided such that a plane normal of the mirror 20 and a plane normal of the mirror 21 are orthogonal to each other.

A first carriage 42 and a second carriage 43 are provided below the glass plate 10. The carriages 42 and 43 function as optical systems.

The mirror 19 is provided in the carriage 42. Driving force is applied to the carriage 42 from the motor 24 via a not-shown belt or the like. The carriage 42 moves in parallel to the surface of the glass plate 10 with the driving force.

A stepping motor is used as the motor 24. The motor 24 is controlled to be driven by a pulse signal or the like from the control substrate 9.

The carriage 43 moves in parallel to the surface of the glass plate 10. The mirrors 20 and 21 are provided in the carriage 43. The driving force from the motor 24 is transmitted to the carriage 43 by the not-shown belt connected to the carriage 42.

A moving direction of the carriages 42 and 43 is a sub-scanning direction of the original document. The sub-scanning direction indicates a direction orthogonal to the main scanning direction. The reading position P with respect to the original document moves from the left to the right according to the movement of the carriages 42 and 43.

The mirror 21 leads the reflected light from the mirror 20 to the lens 22. The lens 22 collects the reflected light from the mirror 21. The lens 22 focuses the light on the surface of the CCD sensor 23.

A four-line CCD is used in the CCD sensor 23. The CCD sensor 23 photoelectrically converts light focused for each of colors. The CCD sensor 23 stores charge for a predetermined time for each of the colors and then outputs charge amount information for each of the colors.

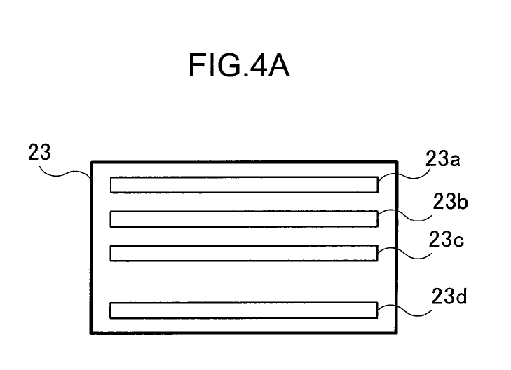

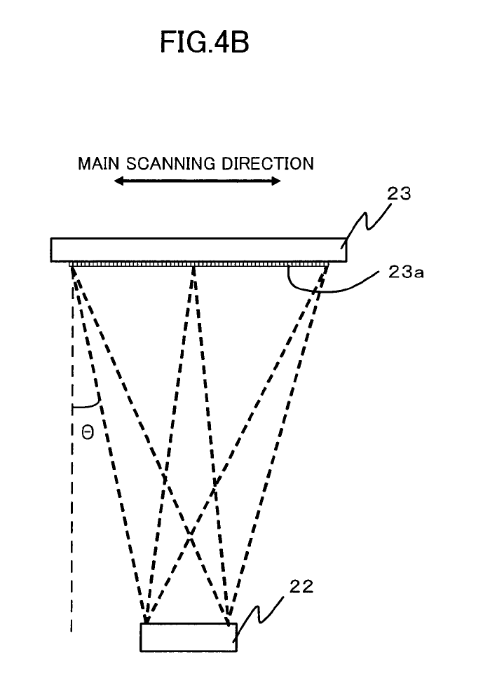

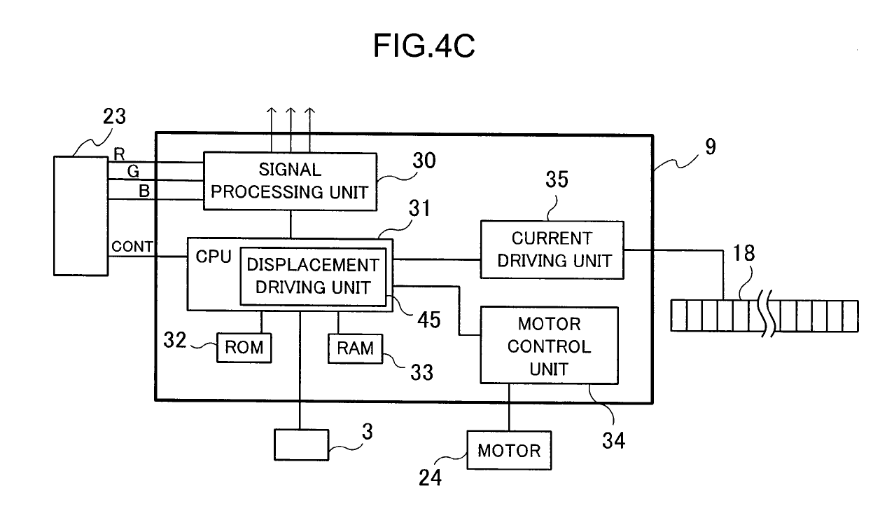

FIG. 4A is a plan view of an imaging surface of the CCD sensor 23. Four line sensors 23a to 23d are provided at a predetermined pitch in the sub-scanning direction.

As an example, the CCD sensor 23 includes a red line sensor 23a for R (red), a green line sensor 23b for G (green), a blue line sensor 23c for B (blue), a monochrome line sensor 23d for black and white, and a not-shown line memory.

The red line sensor 23b photoelectrically converts a red component of light into an R signal indicating the density of red. The red line sensor 23b includes plural photodiodes linearly arranged in the main scanning direction. All the photodiodes arranged in one line receive reflected light from an image of an original document moving in the sub-scanning direction and continuously generate charges in the sub-scanning direction. The red line sensor 23b includes an optical filter that allows light having red wavelength to pass.

The configuration of the green line sensor 23b and the blue line sensor 23c is substantially the same as the configuration of the red line sensor 23a. The monochrome line sensor 23d photoelectrically converts a monochrome component of light into a BW signal indicating the density of white and black. The monochrome line sensor 23d does not include an optical filter. A three-line CCD may be used in the CCD sensor 23.

FIG. 4B is a top view of the lens 22 and the CCD sensor 23. In FIG. 4B, components same as those shown in the figures referred to above are denoted by the same reference numerals and signs. In the figure, an example of a horizontal surface including the lens 22 and the CCD sensor 23 viewed from above is shown.

A light beam from the lens 22 is irradiated on effective reading width in the longitudinal direction of the CCD sensor 23. A distribution in the main scanning direction of an amount of light focused on the surface of the CCD sensor 23 mainly depends on the cosine fourth power law of the lens 22. An amount of light passing through the lens 22 changes according to the size of an incident angle θ of the light with respect to the optical axis of the lens 22. The amount of light passing through the lens 22 decreases in proportion to cos⁴ θ.

If current control is not performed, an amount of light in a peripheral portion of an angle of view decreases more than an amount of light in the center of the angle of view. An amount of light from the lens 22 is non-uniformly distributed along the main scanning direction such that an amount of light has a peak in the position of the optical axis on the imaging surface.

In the first embodiment, a driver circuit for current control corrects a value of an electric current applied to the light source 18 and uniformalizes the distribution of an amount of light on the CCD sensor 23.

The reading position P in FIG. 1 moves in the sub-scanning direction, whereby an image of four lines extending in the main scanning direction is generated on the imaging surface of the CCD sensor 23. The CCD sensor 23 outputs image data to the control substrate 9 through a harness 44.

When scanning of an original document by the carriages 42 and 43 is completed, the CCD sensor 23 outputs information concerning intensities of colors R, G, and B of the entire original document and information concerning luminances of the colors R, G, and B.

The control substrate 9 performs processing to correct shift and outputs hue information. The control substrate 9 samples, for the respective colors, amounts of charges corresponding to an amount of light and outputs image signals of R, G, and B.

FIG. 4C is a diagram of a configuration example of a control system for the MFP 1. In FIG. 4C, components same as those shown in the figures referred to above are denoted by the same reference numerals.

The control substrate 9 includes a signal processing unit 30, a CPU (Central Processing Unit) 31, a ROM (Read Only Memory) 32, a RAM (Random Access Memory) 33, a motor control unit 34, and a current driving unit (a driving unit) 35.

The signal processing unit 30 processes and outputs a signal from the CCD sensor 23.

The processing by the signal processing unit 30 includes conversion of an analog signal from the CCD sensor into a digital signal, shading correction, and adjustment of timing of processing among image signals from the red line sensor 23a, the green line sensor 23b, and the blue line sensor 23c.

The CPU 31 manages control of reading of an original document in the document conveying unit 3 and the scanner 4 and control of the operation of the print process unit 6. The ROM 32 has stored therein a control program for performing image reading operation. The RAM 33 is a work memory.

The CPU 31, the ROM 32, and the RAM 33 configure a displacement driving unit 45. The displacement driving unit 45 operates in association with the operation of the document conveying unit 3 and moves an original document and the optical systems relatively to each other. The motor control unit 34 is an IC (Integrated Circuit) configured to control to drive the motor 24.

The current driving unit 35 is a driving unit and a driver circuit configured to increase and reduce an electric current to the light source 18 is used in the current driving unit 35. A value of the electric current depends on, for example, a characteristic of a circuit element incorporated therein. The current driving unit 35 supplies the electric current having the value to the light source 18. The driver circuit is an LSI (Large Scale Integration) or the like and includes plural not-shown current control circuits.

As an example, the respective current control circuits are realized by switching elements that can be driven to be turned on and off by an electric current such as transistors and elements that can output a constant current such as regulators or other diodes.

As an example, according to ON and OFF commands from the CPU 31, 24 volts and 0 volts are applied to the respective current control circuits to drive the supply of electric currents. Electric currents from the respective current control circuits are supplied to the respective LED chips 26 via the not-shown wiring pattern.

In FIG. 1, an image-signal output unit 47 includes the substrate 25, the LED chips 26, the carriages 42 and 43, the lens 22, the CCD sensor 23, and the signal processing unit 30.

The image processing unit 5 converts image data of the three colors R, G, and B from the control substrate 9 into four print colors Y, NI, C, and K.

The print process unit 6 includes image forming units 6a, 6b, 6c, and 6d respectively for yellow, magenta, cyan, and black.

The image forming unit 6a for yellow includes a photoconductive drum, a charging unit configured to charge the outer circumferential surface of the photoconductive drum, an exposing unit configured to irradiate a laser beam on the photoconductive drum, a developing unit configured to visualize an electrostatic latent image on the photoconductive drum with a developer, and a transfer unit configured to feed a sheet to a photoconductive member and transfer a visualized developer image onto the sheet. The photoconductive drum, the charging unit, the exposing unit, the developing unit, and the transfer unit are not shown in the figure.

The image forming unit 6b for magenta, the image forming unit 6c for cyan, and the image forming unit 6d for black are substantially the same as the image forming unit 6a for yellow.

The sheet having toner images of the four colors transferred thereon by the print process unit 6 is conveyed to the fixing unit 8a. The fixing unit 8a heats the sheet to determined temperature, melts the toner images on the sheet, and fixes the toner images to the sheet.

The paper discharge unit 8b discharges the sheet subjected to the fixing by the fixing unit 8a from the housing 2.

Plural bundles of sheets are set in the paper feeding unit 7. The paper feeding unit 7 picks up the sheets one by one and feeds the sheet to the print process unit 6.

A method of controlling current supply from the current driving unit 35 to the light source 18 in the scanner 4 and the MFP 1 having the configurations is explained below.

Both curvatures in the main scanning direction of an incident surface and an emission surface of the lens 22 have curvature values that increase further away from the optical axis to both the sides of the lens 22. The lens surfaces have center area including an optical axis of reflected light from the mirror 21 and peripheral areas located around the center areas.

The current driving unit 35 changes, for each of the LED chips 26, amounts of light of the linear LED chips 26 arranged at equal intervals. The plural current control circuits supply electric currents having different values to the light source 18 to correct a distribution of light in the main scanning direction.

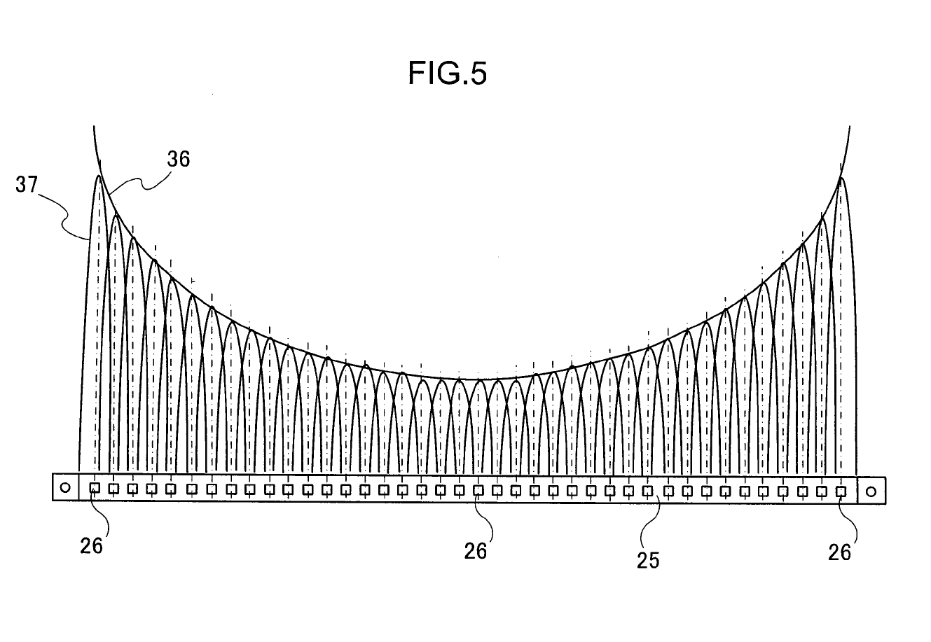

FIG. 5 is a diagram of a distribution of light of the light source 18 controlled by the current driving unit 35. In FIG. 5, components same as those shown in the figures referred to above are denoted by the same reference numerals. The longitudinal direction of the substrate 25 is the main scanning direction. Upper surfaces of the plural LED chips 26 and light beams of light from the LED chips 26 are shown in association with each other.

An incident angle of light made incident on the LED chip 26 located in the center of the substrate 25 is 0. The LED chips 26 in two places located at both the ends of the substrate 25 respectively receive light beams made incident at an incident angle larger than the incident angle of the light beam made incident on the LED chip 26 in the center from the lens 22.

The current driving unit 35 controls electric currents applied to the respective LED chips 26 such that amounts of received light in the LED chips 26 at both the ends supplement an amount of a light beam that is emitted from a peripheral area on the lens surface of the lens 22 and decreases. The respective LED chips 26 emit light beams having substantially the same directivities.

The plural LED chips 26 are arranged on an LED substrate 25 at equal intervals in the main scanning direction. The LED chips 26 expose an original document in the main scanning direction of the scanner 4.

In this embodiment, to control amounts of light from the respective LED chips 26, the current control circuits connected to the respective LED chips 26 are provided (not shown). The current control circuits respectively supply electric currents having different values to the LED chips 26.

The plural current control circuits respectively output electric currents such that both the LED chips 26 located at the ends in the main scanning direction out of all of the LED chips 26 have a maximum amount of light. The current control circuit connected to the LED chip 26 located in the center in the main scanning direction outputs an electric current having a minimum value to the LED chip 26 in the center.

The CPU 31 or the current driving unit 35 sets an amount of light in the main scanning direction in advance to cancel a decrease in an amount of light due to the curvatures of the lens 22. The current driving unit 35 controls electric currents supplied to the respective LED chips 26 such that a curve of levels of amounts of light coincides with a cos θ⁴ curve 36 shown in FIG. 5.

An electric current of the LED chip 26 located in the center is the smallest. Electric currents of the LED chips 26 located at both the ends are the largest. Consequently, a distribution of amounts of light in the main scanning direction on the light receiving surface of the CCD sensor 23 is corrected.

A distribution of values of electric currents of the plural LED chips 26 respectively located between the center and both the ends has a shape gradually rising from the minimum current in the center to the maximum currents at both the ends.

Light deflected by the mirror 21 is refracted on the incident surface of the lens 22. An amount of light in the peripheral portion of the angle of view does not decrease. Amounts of distributed light are prevented from decreasing at both the ends in the longitudinal direction of the CCD sensor 23 in the entire range that should be exposed.

Amounts of distributed light do not decrease at both the ends of the CCD sensor 23. The image processing unit 5 corrects, by performing shading correction, fluctuation in luminance in pixel units. An S/N ratio of a line sensor output is improved. Therefore, an S/N ratio of an image signal is not deteriorated and a satisfactory image signal is obtained.

### Second Embodiment

In the first embodiment, the LED chips 26 as control targets are separately controlled. However, all the LED chips 26 may be controlled with a predetermined number of LED chips 26 set as one group.

An image reading apparatus according to a second embodiment is also a scanner. An image forming apparatus according to the second embodiment is also an MFP. The scanner is provided in the MFP.

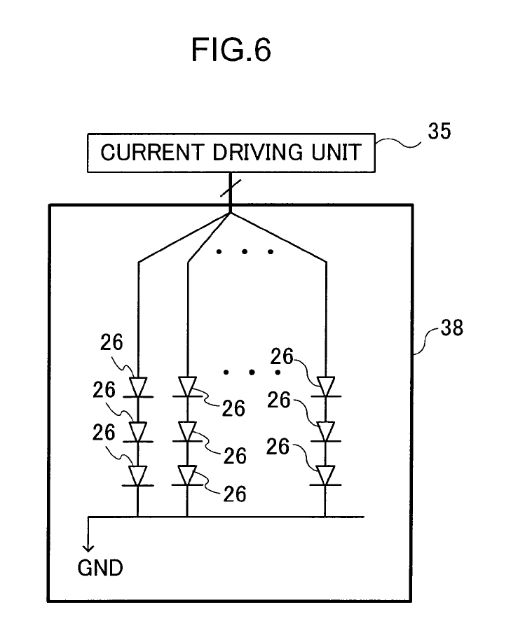

FIG. 6 is a circuit block diagram of a light source used in the image reading apparatus according to the second embodiment. In FIG. 6, components same as those shown in the figures referred to above are denoted by the same reference numerals.

Alight source 38 includes plural LED groups arranged in parallel, each including three LED chips 26 connected in series. The respective LED groups are connected in parallel between the current driving unit 35 side and a grounding conductor.

The LED chips 26 are provided at equal intervals. The light source 38 different from the light source 18 in the first embodiment is incorporated in the scanner 4 in advance. On a circuit board used in the light source 38, a circuit pattern of three LED chips 26 connected in series and a circuit pattern of plural LED groups connected in parallel are formed in advance.

Other components in the scanner excluding the light source 38 are substantially the same as those of the scanner 4 in the first embodiment.

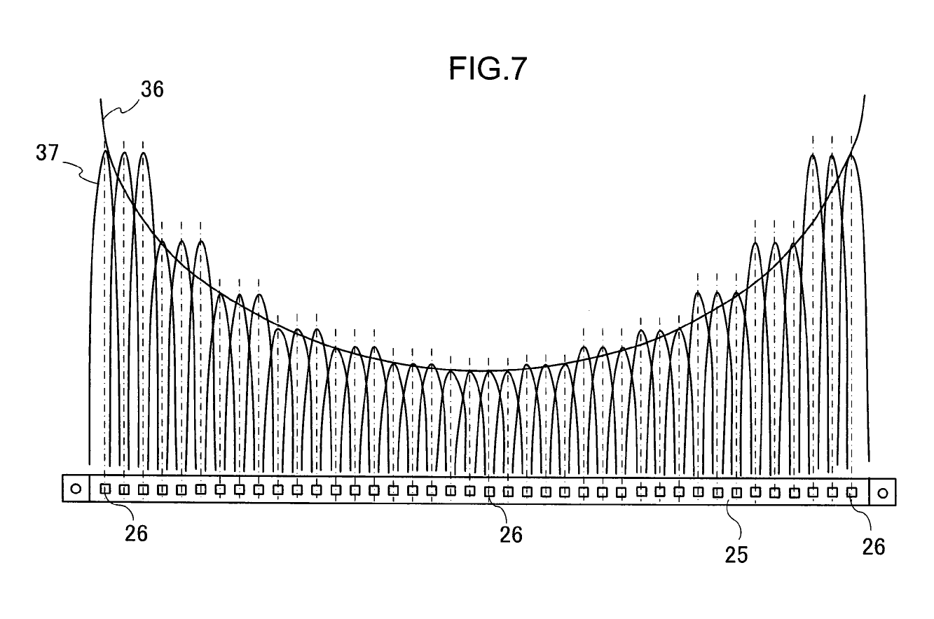

FIG. 7 is a diagram of a distribution of light of the light source 38. In FIG. 7, components same as those shown in the figures referred to above are denoted by the same reference numerals. Reference numeral 37 denotes an amount of a light distribution per one LED chip 26.

With such a configuration, the current driving unit 35 controls plural sets of LED groups. The current driving unit 35 supplies the same electric current to three LED chips 26 adjacent to each other such that the three LED chips 26 have the same amount of light. The current driving unit 35 supplies electric currents to the plural sets of LED groups such that the LED groups have different current values.

The number of current control circuits is equal to or smaller than the number of LED groups. When the current control circuits are provided for the respective three LED chips 26, the three LED chips 26 share the same current control circuit.

Since electric currents supplied to one LED group have the same value, the three LED chips 26 emit light with the same light emission amount.

The current driving unit 35 controls electric currents supplied to the respective LED chips 26 such that a curve of levels of amounts of light coincides with the cos θ⁴ curve 36.

Consequently, a distribution of light in the main scanning direction is corrected. The distribution of light is corrected such that an amount of light increases or decreases for each of the three LED chips 26.

With the image reading apparatus and the image forming apparatus according to the second embodiment, compared with those according to the first embodiment, it is possible to reduce the number of current control circuits.

The LED chips 26 are divided into groups each including three LED chips 26. Values of electric currents fed to the respective groups are varied to change a distribution of amounts of light. Therefore, it is possible to correct a decrease in an amount of light around the lens. It is also possible to improve an S/N ratio of an image signal by performing shading correction.

One LED group may be arranged in the same substrate together with the current control circuit.

### Third Embodiment

In the second embodiment, all the LED chips 26 are divided into the groups each including three LED chips 26. However, the number of LED chips 26 included in one LED group may be changed.

An image reading apparatus according to a third embodiment is also a scanner. An image forming apparatus according to the third embodiment is also an MFP. The scanner is provided in the MFP.

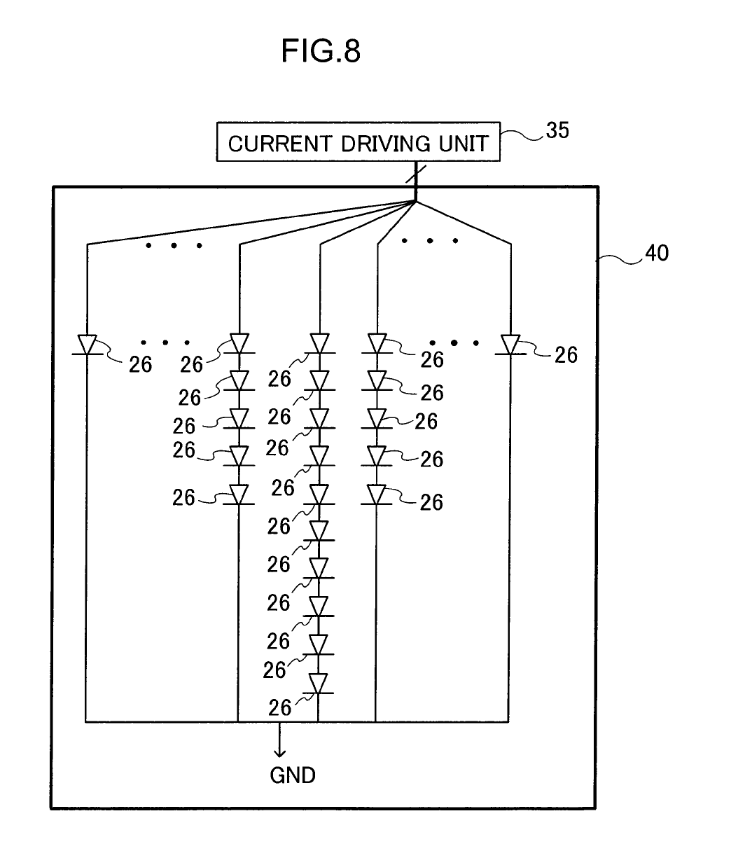

FIG. 8 is a circuit block diagram of a light source used in the image reading apparatus according to the third embodiment. In FIG. 8, components same as those shown in the figures referred to above are denoted by the same reference numerals. A light source 40 generates light irradiated on an original document.

Other components in the scanner excluding the light source 40 are substantially the same as those of the scanner 4 in the first embodiment.

The light source 40 in the third embodiment is the same as the light source 38 in the second embodiment in that plural LED groups are connected in parallel to one another. The light source 40 is different from the light source 38 in that the number of LED chips 26 connected in series is different for each of LED groups.

On a not-shown substrate of the light source 40, the LED chips 26 are arranged at equal intervals in the longitudinal direction of the substrate. Depending on a wiring pattern, the number of LED chips 26 included in the LED groups arranged at both the ends is smaller than the number of LED chips 26 included in the LED group arranged in the center.

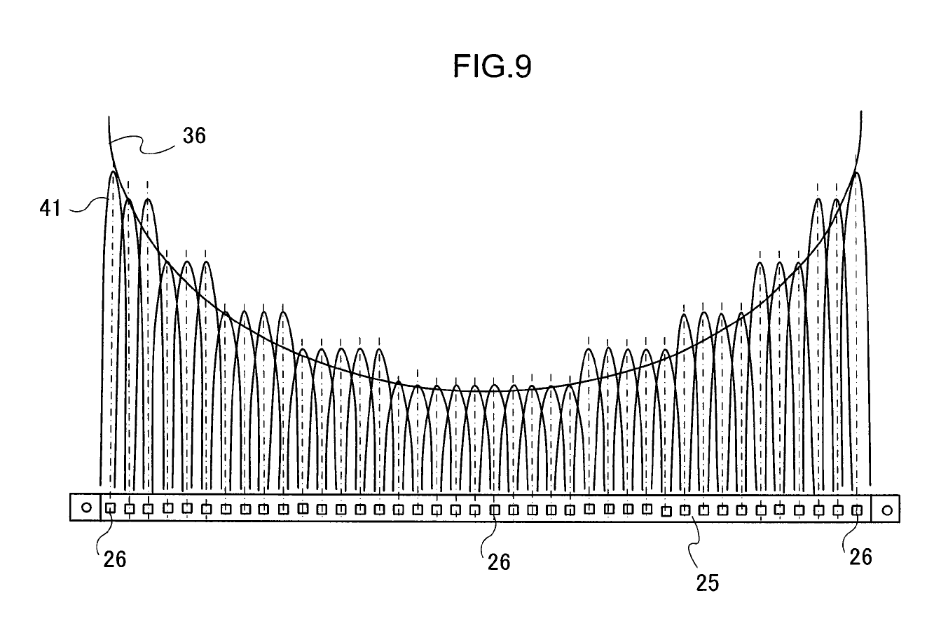

FIG. 9 is a diagram of a distribution of light of the light source 40. In FIG. 9, components same as those shown in the figures referred to above are denoted by the same reference numerals. Reference numeral 41 denotes an amount of a light distribution per one LED chip 26.

Ten LED chips 26 in the center of an LED substrate are divided as one LED group to be controlled. The current driving unit 35 performs driving control to reduce electric currents to the ten LED chips 26.

The current driving unit 35 supplies large currents to the LED chips 26 respectively provided at both the ends in the light source 40.

The current driving unit 35 controls electric currents supplied to the respective LED chips 26 such that a curve of levels of amounts of light coincides with the cos θ⁴ curve 36.

In the third embodiment, compared with the second embodiment, it is possible to further simplify a wiring structure.

With the image reading apparatus and the image forming apparatus according to the third embodiment, it is possible to correct a decrease in an amount of light around a lens by changing the number of LED chips 26 arranged in series and a current value. It is also possible to improve an S/N ratio of an image signal by performing shading correction.

### Fourth Embodiment

In the first to third embodiments, the driving of an electric current is a current control type. However, the driving of an electric current may be a voltage control type.

An image reading apparatus according to a fourth embodiment is also a scanner. An image forming apparatus according to the fourth embodiment is also an MFP. The scanner is provided in the MFP.

A controller substrate 9A configured to change an electric current to the LED chips 26 by performing voltage control is provided in the MFP 1 (FIG. 1). A voltage driving unit is provided instead of the current driving unit 35. Resistors are connected in series to the LED chips 26.

Other components in the scanner 4 excluding the controller substrate 9A, the voltage driving unit, and the resistor are substantially the same as those of the scanner 4 in the first embodiment.

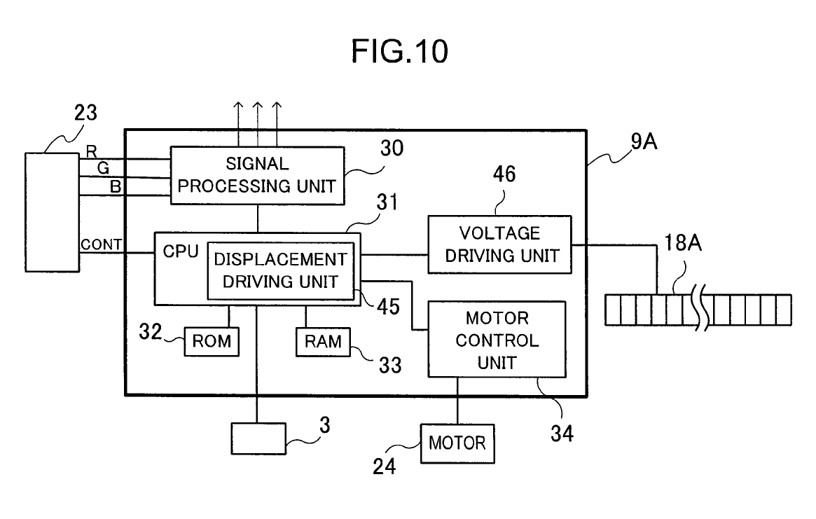

FIG. 10 is a diagram of a configuration example of a control system for the image forming apparatus according to the fourth embodiment. In FIG. 10, components same as those shown in the figures referred to above are denoted by the same reference numerals. A voltage driving unit as a driving unit is provided in the controller substrate 9A. The voltage driving unit 46 controls an electric current applied to a light source 18A by performing voltage control.

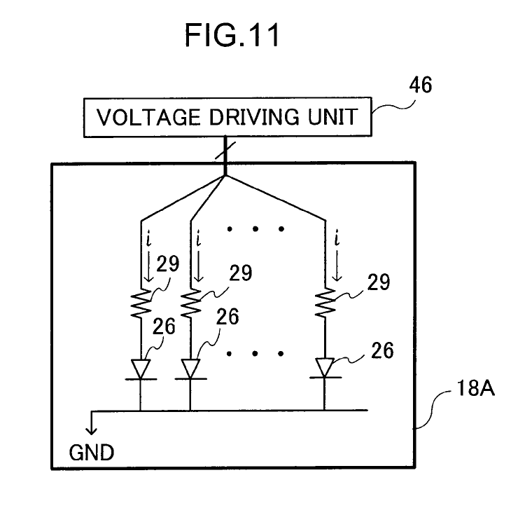

FIG. 11 is a circuit block diagram of the light source 18A. In FIG. 11, components same as those shown in the figures referred to above are denoted by the same reference numerals. In the light source 18A, resistors 29 having different values are respectively connected to the LED chips 26.

The voltage driving unit 46 changes voltages biased to the LED chips 26. Values of the resistors 29 and values of the bias voltages are determined in advance. A switching element or the like that can output a fixed voltage is used in the voltage driving unit 46.

The voltage driving unit 46 performs voltage driving with different values. Electric currents of desired values are supplied to the respective resistors 29. Electric currents to the LED chips 26 at both the ends are controlled to be larger than an electric current to the LED chip 26 in the center. Consequently, an effect same as that in the first embodiment is obtained.

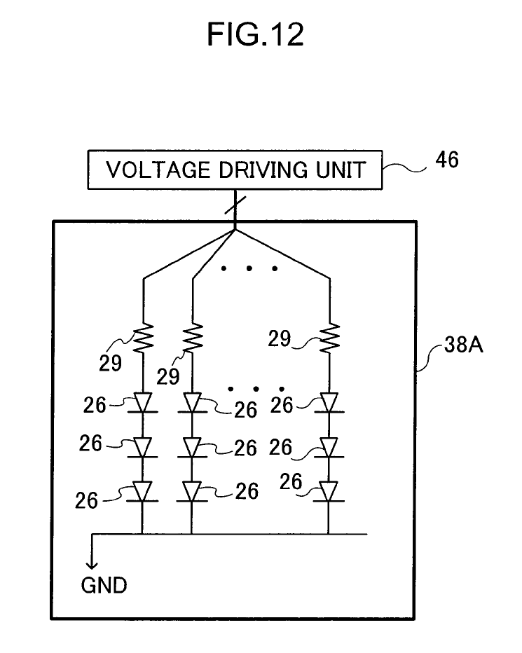

An example corresponding to the light source 38 shown in FIG. 6 is shown in FIG. 12. FIG. 12 is a circuit block diagram of a light source 38A including the resistors 29. With the light source 38A, an effect same as that in the second embodiment is obtained.

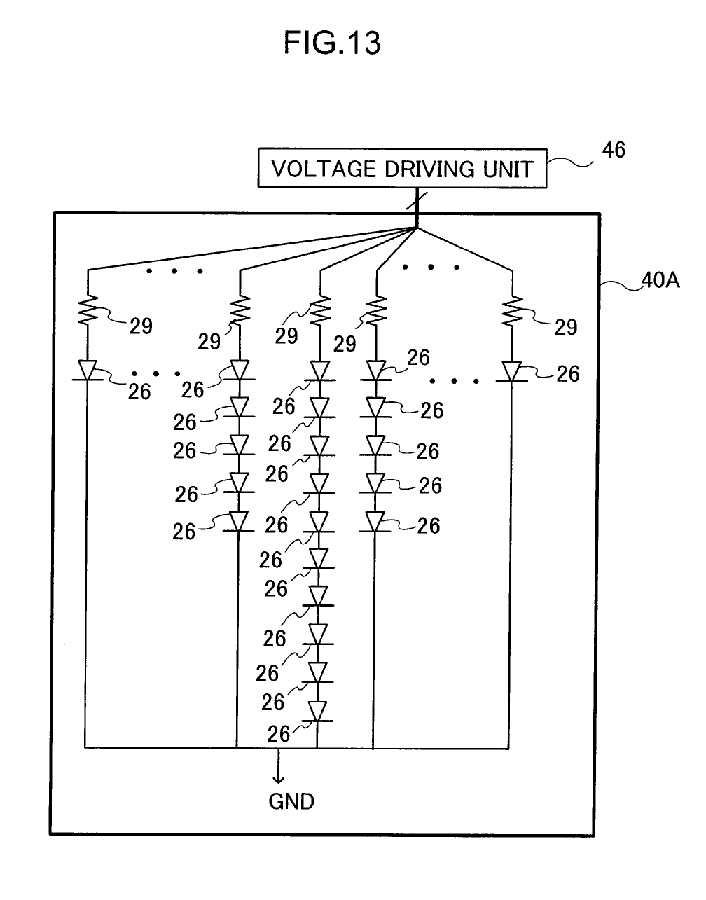

An example corresponding to the light source 40 shown in FIG. 8 is shown in FIG. 13. FIG. 13 is a circuit block diagram of a light source 40A including the resistors 29. With the light source 40A, an effect same as that in the third embodiment is obtained.

### Other Embodiments

The current driving unit 35 and the voltage driving unit 46 are respectively provided in the controller substrate 9 and 9A. However, the current driving unit 35 and the voltage driving unit 46 may be respectively provided in substrates for the light source 18, 28, or 40 and the light source 18A, 38A, or 40A. In this case, the current driving unit 35 on the LED array side functions as a driver circuit to separately control electric currents to the LED chips 26. Alternatively, the voltage driving unit 46 on the LED array side separately controls voltages applied to the LED chips 26.

Concerning a method of driving by the current driving unit 35, as an example, the potential on an anode side of the LED chips 26 is raised to conduct an electric current. However, the potential on a cathode side may be lowered to conduct an electric current.

Various circuit devices can be used in the voltage driving unit 46.

In the embodiments, the number of the LED chips 26 connected in series can be changed to various numbers.

The controller substrates 9 and 9A may be divided into controller substrates for the scanner 4 and controller substrates for image processing.

The configurations of the current driving unit 35 and the voltage driving unit 46 can be changed to various configurations. The superiority of the present invention is maintained over inventions merely carried out by changing the configurations.

Organic Electro-Luminescence may be used for the light-emitting elements.

Although exemplary embodiments of the present invention have been shown and described, it will be apparent to those having ordinary skill in the art that a number of changes, modifications, or alternations to the invention as described herein may be made, none of which depart from the spirit of the present invention. All such changes, modifications, and alterations should therefore be seen as within the scope of the present invention.

What is claimed is:

1. An image reading apparatus comprising:
an image-signal output unit including a substrate, plural light-emitting elements provided at equal intervals in a main scanning direction on the substrate, an optical system configured to condense reflected light from an original document exposed by the light-emitting elements, a lens configured to collect reflected light from the optical system, plural photoelectric conversion elements provided in the main scanning direction and configured to photoelectrically convert light from the lens, and a signal processing unit configured to generate line image data in the main scanning direction of the original document using signals obtained by the photoelectric conversion; and
a driving unit configured to control electric currents applied to the light-emitting elements such that amounts of received light in the photoelectric conversion elements at both ends in the main scanning direction among the plural photoelectric conversion elements of the image-signal output unit, the photoelectric conversion elements at both ends receiving a light beam made incident at an incident angle larger than an incident angle of a light beam made incident on the photoelectric conversion element in a center in the main scanning direction from the lens, supplement an amount of a light beam that is emitted from a peripheral area on a lens surface of the lens and decreases.

2. The apparatus of claim 1, wherein the driving unit controls the electric current to the light-emitting element located at one end in the main scanning direction on the substrate to be larger than the electric current to the light-emitting element located in the center in the main scanning direction.

3. The apparatus of claim 1, wherein
the plural light-emitting elements include plural sets of light-emitting element groups arranged in parallel to one another, each of the light-emitting element groups including a predetermined number of the light-emitting elements connected in series, and
the driving unit supplies electric currents having substantially same values respectively to the light-emitting elements connected in series and causes the light-emitting elements to emit light with substantially same light emission amounts.

4. The apparatus of claim 3, wherein a number of the light-emitting elements included in the one light-emitting element group is the same among the sets of the light-emitting element groups.

5. The apparatus of claim 3, wherein a number of the light-emitting elements in the light-emitting element group, to which the light-emitting element arranged in the center in the main scanning direction on the substrate belongs, is small compared with a number of the light-emitting elements in the light-emitting element group to which the light-emitting element arranged at one end in the main scanning direction belongs.

6. The apparatus of claim 1, wherein a characteristic between driving current values and light emission amounts of the plural light-emitting elements is substantially same among the plural light-emitting elements.

7. An image reading apparatus comprising:
a substrate configured to extend in a main scanning direction;
plural light-emitting elements provided at equal intervals in the main scanning direction on the substrate;
a reflecting member configured to reflect light from an original document exposed by the plural light-emitting elements;
a lens configured to have a lens surface including a center area including an optical axis of reflected light from the reflecting member and a peripheral area located around the center area;
plural photoelectric conversions elements provided in the main scanning direction and configured to receive light collected by the lens and convert the light into electric signals;
a signal processing unit configured to generate line image data in the main scanning direction of the original document using the electric signals from the plural photoelectric conversion elements; and
a driving unit configured to control electric currents applied to the light-emitting elements corresponding to the line image data generated by the signal processing unit such that amounts of received light in the photoelectric conversion elements at both ends in the main scanning direction among the plural photoelectric conversion elements, the photoelectric conversion elements at both ends receiving a light beam made incident at an incident angle larger than an incident angle of a light beam made incident on the photoelectric conversion elements in a center in the main scanning direction from the lens, supplement an amount of a light beam that is emitted from the peripheral area of the lens and decreases.

8. The apparatus of claim 7, wherein
the plural light-emitting elements include plural sets of light-emitting element groups arranged in parallel to one another, each of the light-emitting element groups including a predetermined number of the light-emitting elements connected in series, and
the driving unit supplies electric currents having substantially same values respectively to the light-emitting elements connected in series and causes the light-emitting elements to emit light with substantially same light emission amounts.

9. The apparatus of claim 8, wherein a number of the light-emitting elements included in the one light-emitting element group is the same among the sets of the light-emitting element groups.

10. The apparatus of claim 8, wherein a number of the light-emitting elements in the light-emitting element group, to which the light-emitting element arranged in the center in the main scanning direction on the substrate belongs, is small compared with a number of the light-emitting elements in the light-emitting element group to which the light-emitting element arranged at one end in the main scanning direction belongs.

11. The apparatus of claim 1, wherein the control of the electric currents by the driving unit is a current control type.

12. The apparatus of claim 1, wherein the control of the electric current by the driving unit is a voltage control type.

13. An image forming apparatus comprising:
an image-signal output unit including a substrate, plural light-emitting elements provided at equal intervals in a main scanning direction on the substrate, an optical system configured to condense reflected light from an original document exposed by the light-emitting elements, a lens configured to collect reflected light from the optical system, plural photoelectric conversion elements provided in the main scanning direction and configured to photoelectrically convert light from the lens, and a signal processing unit configured to generate line image data in the main scanning direction of the original document using signals obtained by the photoelectric conversion;
a driving unit configured to control electric currents applied to the light-emitting elements such that amounts of received light in the photoelectric conversion elements at both ends in the main scanning direction among the plural photoelectric conversion elements of the image-signal output unit, the photoelectric conversion elements at both ends receiving a light beam made incident at an incident angle larger than an incident angle of a light beam made incident on the photoelectric conversion elements in a center in the main scanning direction from the lens, supplement an amount of a light beam that is emitted from a peripheral area on a lens surface of the lens and decreases;
an image processing unit configured to accumulate, in a sub-scanning direction, the line image data outputted by the image reading unit under the control by the driving unit and generate an image signal; and
a print process unit configured to form, on a recording medium, the image signal from the image processing unit.

14. The apparatus of claim 13, wherein the driving unit controls the electric current to the light-emitting element located at one end in the main scanning direction on the substrate to be larger than the electric current to the light-emitting element located in the center in the main scanning direction.

15. The apparatus of claim 13, wherein
the plural light-emitting elements include plural sets of light-emitting element groups arranged in parallel to one another, each of the light-emitting element groups including a predetermined number of the light-emitting elements connected in series, and
the driving unit supplies electric currents having substantially same values respectively to the light-emitting elements connected in series and causes the light-emitting elements to emit light with substantially same light emission amounts.

16. The apparatus of claim 15, wherein a number of the light-emitting elements included in the one light-emitting element group is the same among the sets of the light-emitting element groups.

17. The apparatus of claim 15, wherein a number of the light-emitting elements in the light-emitting element group, to which the light-emitting element arranged in the center in the main scanning direction on the substrate belongs, is small compared with a number of the light-emitting elements in the light-emitting element group to which the light-emitting element arranged at one end in the main scanning direction belongs.

18. The apparatus of claim 13, wherein a characteristic between driving current values and light emission amounts of the plural light-emitting elements is substantially same among the plural light-emitting elements.

19. The apparatus of claim 13, further comprising:
a transparent member with which a surface of the original document comes into contact;
a document conveying unit configured to convey the original document in the sub-scanning direction on the transparent member; and
a displacement driving unit configured to relatively move the original document and the optical system in association with operation of the document conveying unit.

20. The apparatus of claim 19, wherein the substrate is held with a substrate surface inclined to face a reading position on a rear surface of the transparent member.
